(19) United States
(12) Patent Application Publication
(10) Pub. No.: US 2014/0045502 A1
(43) Pub. Date: Feb. 13, 2014

(54) COMMUNICATION BETWEEN A USER EQUIPMENT AND A BASE STATION

(71) Applicant: Mindspeed Technologies U.K., Limited, Bath (GB)

(72) Inventors: Nicholas William Whinnett, Wilts (GB); Fiona Clare Angharad Somerville, Bristol (GB)

(73) Assignee: Mindspeed Technologies U.K., Limited, Bath (GB)

(21) Appl. No.: 14/058,219

(22) Filed: Oct. 19, 2013

Related U.S. Application Data
(63) Continuation of application No. 13/449,136, filed on Apr. 17, 2012.

(30) Foreign Application Priority Data
Apr. 18, 2011 (GB) GB 1106517.4

(51) Int. Cl. H04W 36/06

(52) U.S. Cl. CPC H04W 36/06
USPC 455/437; 455/438

(57) ABSTRACT

Method, multi-mode base station and computer program product for controlling communication between a user equipment (UE) and the multi-mode base station, the multi-mode base station being arranged to operate as a plurality of cells, the plurality of cells comprising a first cell using a first radio access technology and a second cell using a second radio access technology. The UE is operating in the first cell. Operating conditions of the first and second cells are monitored, and based on the monitored operating conditions of the first and second cells, it is determined that making a handover of the UE to the second cell would provide a performance improvement. In response to determining that making a handover of the UE to the second cell would provide a performance improvement, a handover is made of the UE to the second cell, thereby providing the performance improvement.

### PRIORITY CLAIM

This application is a continuation of and claims priority to U.S. patent application Ser. No. 13/449,136 filed Apr. 17, 2012, which claims priority to and the benefit of Great Britain Patent Application No. 1106517.4 filed on Apr. 18, 2011.

### FIELD OF THE INVENTION

The present invention relates to communication between user equipment and a base station and in particular to controlling communication between user equipment and a multi-mode base station (such as multimode picocell, femtocell or the like) which is arranged to operate as two or more logical cells.

### RELATED ART

As will be familiar to a person skilled in the art, a base station is the unit which provides a user equipment such as a mobile phone or computer with access to a wireless cellular network such as a network operating according to both 3G and 4G standards, the base station being the first stage up from the user equipment in the cellular hierarchy, i.e. the unit with which the user equipment immediately communicates via a wireless connection (without an intermediary station). According to 3GPP terminology, a base station is sometimes referred to as a “node B”, but the more generic term “base station” will be maintained herein for convenience.

A femtocell is a type of cellular base station designed to operate over a relatively short range compared to a conventional base station. Short-range dedicated base stations such as femtocells have become more viable in recent years due to reduction in the cost and size of the electronics required to implement a cellular base station. The idea is to provide a dedicated base station to cover a relatively small geographical area which is expected to experience a high density of users and/or regular usage. For example femtocells are typically intended to be deployed in a small office, shop, café or even the home. Other types of short range base stations include picocells or microcells, typically covering an intermediately sized area; although the scope of femtocells is increasing as they are encroaching on what have been traditionally called picocells and microcells, supporting large offices, shopping malls and outdoor deployments. The scope of femtocells is increasing due to increased functionality over picocells and microcells. In some wireless standards, femtocells combine the functionality of several wireless network elements, for example in UMTS a femtocell combines the functionality of a base station and radio network controller (RNC). Also, it is typical for a femtocell to be installed by the end user, not the network operator, and extra functionality is required to support this, such as the ability to locate (sniff) neighbouring base stations. This is in contrast to picocells and microcells that are installed by a network operator and only provide base station functionality.

### SUMMARY

Base-stations (BS), including femtocells, contain a radio resource management (RRM) entity which includes handover mechanisms to decide when a UE should perform hand-out from a cell, and hand-in to that cell. A dual mode femtocell is a base-station operating as two cells, where these cells are using different radio access technologies (RATs) and where each has an associated RRM entity for managing the operation of the respective cell.

When a UE connects to a base-station, the UE will select its RAT based on, for example, a pre-defined order set by a network operator, or the received signal quality at the UE for each available RAT.

The inventors have realised that in a multi-mode base station, such as a dual mode femtocell, if the different cells of the multi-mode base station operate using independent RRM entities, as in the prior art described above, this can lead to inefficient use of base-station resources. In particular, this may lead to a UE being admitted to a cell other than the optimum cell for its quality of service (QOS), or may lead to one cell of the multi-mode base station being fully loaded, while another cell of the multi-mode base station is only lightly loaded. These sub-optimal situations may occur because when a UE connects to a base station, the base station may be unaware of the type of service that the UE intends to use, and the UE may have no knowledge of either the loading state of the cell, or of the interference state of the base station and of the surrounding neighbour base stations. Therefore when the UE selects its RAT, the UE may be admitted into a sub-optimum cell.

The inventors have further realised that where a UE is operating in a sub-optimum cell of a multi-mode base station, it may be advantageous to perform an inter-RAT handover to another cell of the multi-mode base station (which uses another RAT) since this may lead to an improved QOS for communication between the UE and the multi-mode base station. This can be achieved using a joint RRM in a multi-mode base station which manages the resources for the plurality of cells of the multi-mode base station. In this way, a joint RRM can, advantageously, take account of operating conditions of all of the cells of the multi-mode base station when allocating a UE to a particular one of the cells.

According to a first aspect of the invention there is provided a method of controlling communication between a user equipment and a multi-mode base station. In this embodiment the multi-mode base station is arranged to operate as a plurality of cells and the plurality of cells comprise a first cell using a first radio access technology and a second cell using a second radio access technology such that the user equipment is operating in the first cell. In this embodiment the method comprises monitoring operating conditions of the first and second cells and based on the monitored of the operating conditions of the first and second cells, determining that making a handover of the user equipment to the second cell would provide a performance improvement. In response to determining that making a handover of the user equipment to the second cell would provide a performance improvement, making a handover of the user equipment to the second cell, thereby providing the performance improvement.

Advantageously, some embodiments provide a performance improvement by making an inter-RAT handover decision in a joint RRM. This provides for efficient use of resources of the multi-mode base station since occurrences of situations in which the UE operates in a non-optimum cell or in which one cell is significantly more heavily loaded than another cell of the multi-mode base station can be avoided, or at least reduced.

The method steps may be initiated periodically. Alternatively, the method steps may be initiated in response to one of the cells of the multi-mode base station hitting a threshold of low resource availability.

In an embodiment, the first radio access technology is suited to a first set of services and the second radio access technology is suited to a second set of services, such that the step of monitoring the operating conditions of the first and second cells comprises monitoring the services used by the user equipment in the first cell, and the step of determining that making a handover of the user equipment to the second cell would provide a performance improvement. This may comprise determining that the services used by the user equipment in the first cell are in the second set of services. The step of monitoring the services used by the user equipment in the first cell may comprise at least one of the following steps: (i) examining service requests exchanged between the user equipment and the first cell; and (ii) determining Quality of Service parameters applied to the communication between the user equipment and the first cell of the multi-mode base station.

In another embodiment, the step of monitoring the operating conditions of the first and second cells comprises monitoring the throughput at which the user equipment is operating in the first cell, such that the step of determining that making a handover of the user equipment to the second cell would provide a performance improvement comprises determining that the monitored throughput uses all of the bandwidth available to the user equipment in the first cell using the first radio access technology, and that the user equipment could achieve a greater throughput if it operated in the second cell using the second radio access technology.

In a further embodiment, the user equipment is one of a plurality of user equipment operating in the first cell, such that the monitored operating conditions indicate that the first cell has hit a threshold of low resource availability. The step of determining that making a handover of the user equipment to the second cell would provide a performance improvement comprises determining which of the plurality of user equipment have Quality of Service requirements which would be satisfied if the user equipment were operated using the second radio access technology in the second cell. This method may comprise making a handover of the determined user equipment to the second cell.

The user equipment may be one of a plurality of user equipment communicating with the multi-mode base station and the method may comprise determining an effect of operating the multi-mode base station for each of a plurality of different arrangements in which the user equipment is allocated to operate in different ones of the cells to thereby determine an optimum arrangement for allocating the user equipment to operate in the cells and making a handover of at least one of the user equipment between the cells to thereby implement the optimum arrangement.

The performance improvement may be one or more of the following three improvements. An improvement in the throughput or Quality of Service achieved by the user equipment. An improvement in a combined throughput or Quality of Service achieved by a plurality of user equipment communicating with the multi-mode base station. An improvement in a combined throughput or Quality of Service achieved by the user equipment or a plurality of user equipment communicating with at least one of the multi-mode base station, and at least one other neighbouring base station.

The step of monitoring operating conditions may comprise at least one of the following. Receiving, from the user equipment, measurement events of the cells of the multi-mode base station and of neighbouring cells. Receiving, from the user equipment, periodic measurements of the cells of the multi-mode base station and of neighbouring cells. Performing, by the multi-mode base station, periodic measurements of neighbouring cells. Determining periodic indications of victim cell loading received from neighbour cells. Detecting nearby victim user equipment. Measuring noise plus interference at the multi-mode base station. Detecting loading changes on the cells of the multi-mode base station. Determining a change in service class for the user equipment when the user equipment sends a service request to the multi-mode base station.

According to a second aspect of the invention there is provided a multi-mode base station arranged to operate as a plurality of cells, the plurality of cells comprising a first cell using a first radio access technology and a second cell using a second radio access technology. The base station comprises a radio resource manager for controlling communication between a user equipment and the multi-mode base station and the radio resource manager is configured to perform operations in accordance with the method of the first aspect of the invention. The multi-mode base station may be a dual-mode femtocell.

According to a third aspect of the invention there is provided a computer program product for controlling communication between a user equipment and a multi-mode base station. The multi-mode base station is arranged to operate as a plurality of cells, and plurality of cells comprise a first cell using a first radio access technology and a second cell using a second radio access technology. The computer program product is embodied on a non-transient computer-readable medium and configured such that when executed on a processor of the multi-mode base station to perform the operations of the first aspect of the invention.

### BRIEF DESCRIPTION OF THE DRAWINGS

For a better understanding of the present invention and to show how the same may be put into effect, reference will now be made, by way of example, to the following drawings in which:

FIG. 1 is a schematic illustration of a part of a wireless cellular communication network.

FIG. 2 is a flow chart for a method of controlling communication between a user equipment and a multi-mode base station.

### DETAILED DESCRIPTION OF PREFERRED EMBODIMENTS

Various embodiments of the invention will now be described by way of example only.

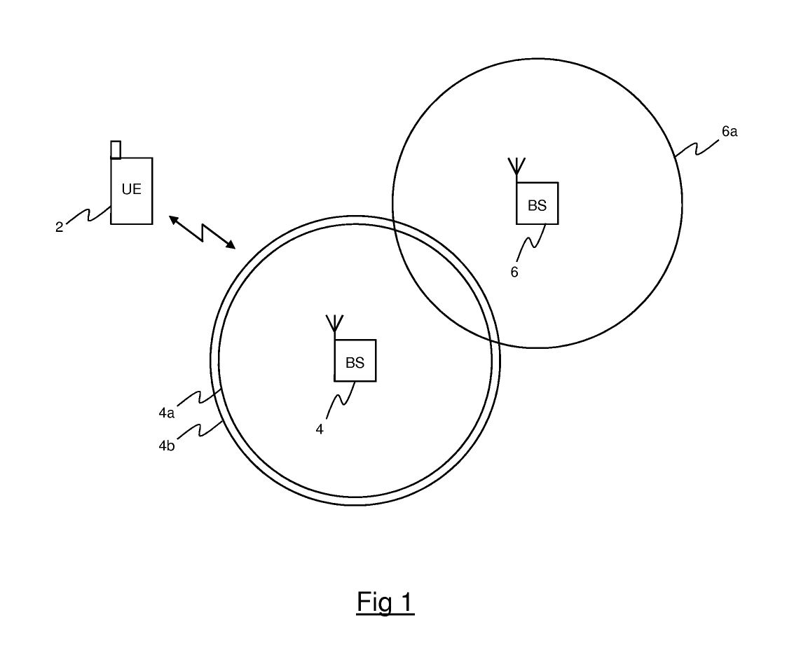

FIG. 1 is a schematic diagram showing a part of a wireless cellular communication network such as a 3G network. The network comprises a user equipment (UE) 2 in the form of a mobile terminal, such as a smart phone or other mobile phone, a tablet, or a laptop or desktop computer equipped with a wireless data card. The network further comprises a base station in the form of a femtocell 4, and one or more further base stations 6. Each base station 4, 6 provides network coverage in the form of at least one respective cell 4a, 4b, 6a.

Furthermore, the femtocell 4 is configured as a dual-mode femtocell. A dual-mode femtocell is a base station operating as two logical cells 4a and 4b. These cells 4a, 4b are configured to operate according to different radio access technologies (RATs), i.e. different telecommunication standards. For example one of the dual cells may be arranged to operate according to a 3G standard such as a Universal Mobile Telecommunications System (UMTS) standard and the other of the dual cells may be arranged to operate according to a 4G standard such as a Long Term Evolution (LTE) standard. The cells 4a, 4b may be arranged to operate in different frequency sub-bands. The reach of the cells 4a, 4b does not necessarily extend across exactly the same geographical area. Range is highly dependent on RAT and frequency, e.g. cell 4a could be twice the size of cell 4b. The arrangement shown in FIG. 1 is only schematic. On a point of terminology, note that “base station” or “femtocell” refers to the unit, whilst “cell” refers to the logical combination of geographical coverage area and access technology or frequency band (also note that in the context of the present application “femtocell” refers to the base station unit rather than the cell). As the two cells 4a, 4b are provided by the same base station unit then they share the same cell centre point, i.e. represent the same geographical node of the network, and they also share at least some of the same hardware resources. For example a dual-mode base station 4 may share the same processor for both cells 4a, 4b, though might not share the same antenna. The dual cells 4a, 4b may also share other base-station functionality, such as configuration management, synchronization and backhaul connection (i.e. same connection to the next element up in the cellular hierarchy).

The invention could apply equally to any multi-mode base station (having at least two cells), but by way of illustration the following embodiments are described in relation to a dual-mode femtocell 4.

The user equipment 2 is arranged to be able to request admission to a particular cell, and when it does so, e.g. requesting admission to cell 4a, to request a particular quality of service. For example it could request to be provided with at least a certain uplink or downlink throughput, or to be provided with no more than a certain uplink or downlink latency.

Each of the base stations (4 and 6) comprises a radio resource management (RRM) entity (or “radio resource manager”) arranged to receive the admission request from the UE, if the UE decides to select it, and decide whether to admit the user equipment 2 to the requested cell. The RRM entity of the dual mode femtocell 4 is a joint RRM entity for the two cells 4a and 4b. In this way the RRM entity for the dual mode femtocell 4 can manage the resources of the two cells 4a and 4b based on information relating to both of the cells (rather than based on information relating to just one of the cells as is used by the independent RRM entities of the prior art described above).

At a higher level of the cellular hierarchy the network may comprise one or more higher-level controller stations, which may be arranged to perform various further management functions. However, the present invention is concerned with radio resource management at the level of a multi-mode base station.

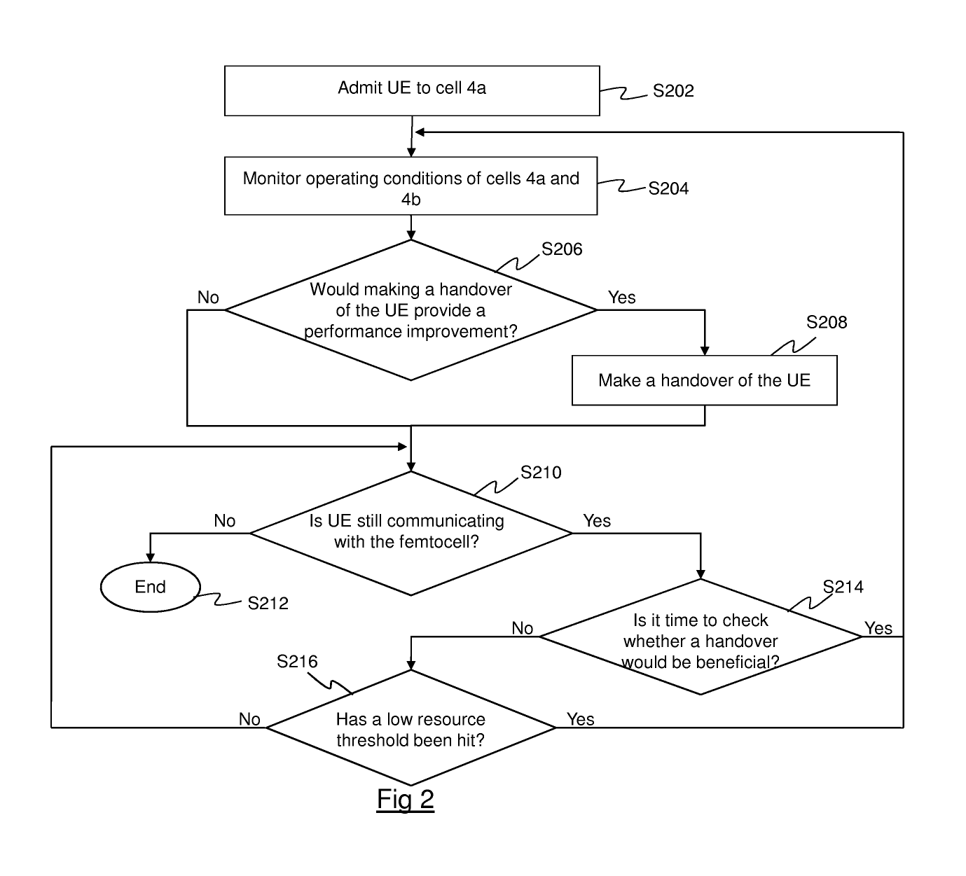

With reference to the flow chart shown in FIG. 2 there is now described a method of controlling communication between the UE 2 and the dual-mode femtocell 4 according to a preferred embodiment.

In step S202, as described above, the UE 2 is admitted to one of the cells of the dual-mode femtocell 4. In the example shown in FIG. 2, the UE 2 is admitted to cell 4a. The precise steps that are undertaken to admit the UE to one of the cells 4a and 4b are outside the scope of the present invention and as such are not described in any further detail herein. The UE 2 operates in the cell 4a to thereby communicate with the dual-mode femtocell 4. FIG. 1 shows only one UE (that being UE 2) in communication with the dual-mode femtocell 4, but there may be multiple UEs in communication with each of the base stations 4 and 6 and multiple UEs operating in each of the cells 4a and 4b at any given time.

In step S204 the operating conditions of the cells 4a and 4b are monitored. The operating conditions of the cell 6 may also be monitored. The monitoring of the operating conditions in step S204 may be performed by the RRM entity of the dual-mode femtocell 4. The operating conditions can be used by the RRM entity to ascertain the quality of service being provided to the UE 2 in the cell 4a. The operating conditions may be monitored by measuring one or more parameters that provide an indication as to the current state of the UE 2 or of at least one of the cells 4a, 4b and 6. Examples of the operating conditions which may be monitored are described in the example scenarios given below.

In step S206 it is determined whether making a handover of the UE 2 (e.g. from the first cell 4a to the second cell 4b) would provide a performance improvement. The performance improvement may be an improvement in the throughput or Quality of Service (QOS) achieved by the UE 2. Alternatively, the performance improvement may be an improvement in a combined throughput or QOS achieved by a plurality of UEs communicating with the dual-mode femtocell 4. Alternatively still, the performance improvement may be an improvement in a combined throughput or QOS achieved by a plurality of UEs communicating with either of the base stations 4 and 6. It can therefore be seen that the performance improvement may relate specifically to the UE 2 or may relate to an overall improvement for a plurality of UEs in communication with the base stations 4 and 6. The RRM entity of the dual-mode femtocell 4 can use information relating to the cells 4a, 4b and 6 in order to perform the determination in step S206 as to whether a handover of the UE 2 would provide a performance advantage (or “performance improvement”).

If in step S206 it is determined that a performance improvement would not be provided by making a handover of the UE 2 then this indicates that the UE 2 is currently operating in the optimum cell. As such, no handover of the UE 2 is performed and the method proceeds to step S210 which is described below.

However, if in step S206 it is determined that a performance improvement would be provided by making a handover of the UE 2 then this indicates that the UE 2 is not currently operating in the optimum cell. In this case the method passes to step S208 in which a handover is made for the UE 2 (e.g. to move the UE 2 from the cell 4a to the cell 4b) to thereby move the UE 2 into a more optimum cell which would provide the performance improvement referred to in step S206. For example, in the dual-mode femtocell 4, the only other cell of the femtocell 4 (other than cell 4a) is cell 4b, and as such the UE 2 hands over to cell 4b from cell 4a. As described above cell 4b uses a different Radio Access Technology (RAT) to cell 4a. The RAT of the cell 4b may provide the performance improvement for the UE 2 as compared to the RAT of the first cell 4a. Following step S208 the method passes to step S210 which is described below.

It can therefore be seen that in this way an inter-RAT handover of the UE 2 can be made when it is determined that doing so will provide a performance improvement. In this way, even if the UE 2 is not admitted to the optimum cell when it is first admitted to the dual-mode femtocell 4, the RRM entity of the dual-mode femtocell 4 can perform a subsequent handover to a more optimal cell. Furthermore, the UE 2 may be admitted to an optimum cell at the time at which the UE 2 is admitted to the dual-mode femtocell 4, but the operating conditions of the cells 4a and 4b may change subsequent to the admission of the UE 2 to a cell, and as such the UE 2 may at some point in time subsequent to admission to the dual-mode femtocell 4, no longer be operating in the optimum cell of the dual-mode femtocell 4. This can be detected by the RRM entity of the dual-mode femtocell 4 and the RRM entity can then perform a handover to a more optimal cell.

Following step S206 or step S208, as described above, the method passes to step S210 in which it is determined whether the UE 2 is still communicating with the dual-mode femtocell 4. If the UE 2 is not still communicating with the dual-mode femtocell 4 then the method passes to step S212 in which the method ends. In this way, when the UE 2 no longer communicates with the dual-mode femtocell 4, the RRM entity of the femtocell 4 does not continue to perform the check of whether the UE 2 is operating in the optimum cell of the dual-mode femtocell 4.

However, if it is determined in step S210 that the UE 2 is still communicating with the femtocell 4 then the method passes to step S214 in which it is determined whether it is time to check whether a handover would be beneficial. If it is determined in step S214 that it is time to check whether a handover of the UE 2 would be beneficial then the method passes back to step S204 and the method repeats. In this way the RRM entity of the dual-mode femtocell 4 can repeatedly check that the UE 2 is operating in the optimum cell of the dual-mode femtocell 4. The method may be repeated periodically. In this case step S214 comprises determining whether the time since the previous execution of the method has exceeding a threshold time and, if it has, then determining that it is time to repeat the check of whether a handover would be beneficial.

However, if it is determined in step S214 that it is not time to check whether a handover of the UE 2 would be beneficial then the method passes to step S216. In step S216 it is determined whether some low-resource available threshold has been hit. If it is determined that the low-resource available threshold has been hit then the method passes back to step S204 and the method repeats. In this way the RRM entity of the dual-mode femtocell 4 can repeatedly check that the UE 2 is operating in the optimum cell of the dual-mode femtocell 4. Therefore, if the resources available in any of the cells 4a, 4b or 6 hit, or drop below, a threshold then the check of whether a handover would be beneficial is repeated. In this way when there is a problem with the service provided in any of the cells, the method can check whether each UE is currently operating in the optimum cell. In this way handovers of the UEs between the cells may be performed which may improve the conditions in the system, and in particular which may raise the available resources in the cell for which the available resources had dropped below the threshold.

If it is not determined in step S216 that the low-resource available threshold has been hit then the method passes back to step S210 and the steps S210, S214 and S216 are repeated until either the method ends in step S212 or the method passes back to step S204 from either step S214 or S216.

The blocks and method steps described in relation to FIG. 2 may be implemented in hardware or in software. Furthermore, there may be provided a computer program product comprising instructions which when executed by computer processing means at the dual-mode femtocell 4 will implement the method described above. In particular, the RRM entity could implement each step in FIG. 2 at the dual-mode femtocell 4.

There are now described some example scenarios in which the method described above can improve the performance within the system shown in FIG. 1.

In a first example scenario, the first cell 4a uses a first Radio Access Technology, RATA, which is better suited to certain services, for example low-delay, low-latency services, whereas the second cell 4b uses a second Radio Access Technology, RATB, which is better suited to other types of service for example high throughput. The joint RRM entity at the dual-mode femtocell 4 can monitor the services being used by the UE 2, either by examining the service requests exchanged between the UE 2 and the higher-layer core network, or from the messages received at the femtocell 4 from the higher-layer core network informing it of the QOS parameters it should apply to the UE air-interface connection. If the UE 2 is currently operating in the first cell 4a, i.e. using RATA, but has a service better suited to RATB, then the joint RRM entity can decide to perform an inter-RAT handover to move the UE 2 from RATA to RATB (i.e. from the first cell 4a to the second cell 4b).

In a second example scenario, the dual-mode femtocell 4 provides a service to the UE 2 in the first cell 4a, i.e. using the first Radio Access Technology, RATA. RATA is able to meet the QOS requirements for the UE 2, for example, RATA can meet the guaranteed bit-rate specified for this connection from the higher-layer core network. However, the UE 2 is operating at a throughput greater than this guaranteed bit-rate and consistently using all available bandwidth to the UE in RATA. The joint RRM entity of the dual-mode femtocell 4 detects this and is aware that if the UE 2 moved to the second cell 4b, and thereby used the second Radio Access Technology, RATB, it could achieve a higher throughput. The joint RRM entity performs an inter-RAT handover to move the UE 2 from RATA to RATB (i.e. from the first cell 4a to the second cell 4b).

In a third example scenario, a plurality of UEs are communicating with the dual-mode femtocell 4. In particular, a plurality of UEs are operating in the cell 4a which uses the first Radio Access Technology, RATA. The first cell 4a reaches a low-resource available threshold when the resources available in the cell 4a are no longer sufficient to provide an acceptable level of service to the plurality of UEs operating in the cell 4a. In this case, the prior art systems described in the background section which use a standalone RRM entity for each cell (4a and 4b) would start the hand-out procedure for the UE with the lowest signal quality in the cell 4a and/or with the best signal quality from a neighbouring cell. Instead, the joint RRM entity described herein can determine which of the UEs in the cell 4a can have their QOS requirements fully satisfied by the second Radio Access Technology, RATB, of the second cell 4b and can trigger an inter-RAT handover for those determined UEs. This decreases the likelihood of a UE seeing a degraded service quality. In addition, it keeps the UEs attached to the femtocell 4 where it would be expected to receive an improved QOS compared to being handed-out to a neighbour macrocell (e.g. cell 6) with the same RAT as the cell 4a, i.e. RATA. Alternatively, if all of the UEs have similar QOS requirements the joint RRM entity can adjust the inter-RAT handover trigger parameters to encourage inter-RAT handover of some UEs from cell 4a to cell 4b, i.e. from RATA to RATB. Handover triggers may be signal quality values broadcast to all UEs in the cell. If the UE 2 detects that the signal quality from cell 4a has fallen below the broadcast value it will indicate this event to the cell 4a. Cell 4a may then start investigating the suitability of handover to cell 4b or to cell 6.

In the methods described above, the operating conditions of the cells 4a and 4b are monitored to determine whether making a handover would provide a performance improvement. The monitoring of the operating conditions may comprise monitoring some, or all, of the following parameters:
UE reported measurement events of serving and neighbour cells;
periodic UE measurements of serving and neighbour cells;
periodic sniffer measurements;
periodic indications of victim cell loading received from neighbour cells;
detection of nearby victim UEs;
updated noise plus interference measurements made at the femtocell;
loading changes on the femtocells; and
changes in service class when UE sends service request (addition/removal of service components).

As described above, the effect of these parameters will be determined either periodically, or when some low-resource available threshold is hit. At this time the effect (e.g. on the level of service that can be provided to the UEs) of supporting different UEs on each RAT can be determined. For example, if there are two UEs (UE1 and UE2) operating in the dual-mode femtocell 4 then the effect of each of the four possible arrangements of allocations of the UEs to the cells 4a and 4b can be determined in order to determine which arrangement provides for the optimum allocation of UEs to the cells. The four arrangements in this example are:
UE1 in RATA, UE2 in RATA;
UE1 in RATA, UE2 in RATB;
UE1 in RATB, UE1 in RATA; and
UE1 in RATB, UE1 in RATB.

The most efficient combination of the UEs and the RATs can then be selected. If the optimum combination involves moving a UE from RATA to RATB, or vice versa, then the joint RRM entity will perform an inter-RAT handover as described above.

While this invention has been particularly shown and described with reference to preferred embodiments, it will be understood to those skilled in the art that various changes in form and detail may be made without departing from the scope of the invention as defined by the following claims.

What is claimed is:

1. A method of controlling communication between a user equipment and a multi-mode femtocell base station, the multi-mode femtocell base station being arranged to operate as a plurality of cells, the plurality of cells comprising a first cell using a first radio access technology and a second cell using a second radio access technology, the method comprising:
monitoring operating conditions of the first cell and the second cell, the user equipment operating in the first cell;
based on the monitored operating conditions of the first cell and the second cell, determining that making a handover of the user equipment to the second cell would provide a performance improvement; and
in response to determining that making a handover of the user equipment to the second cell would provide a performance improvement, making a handover of the user equipment to the second cell to provide the performance improvement.

2. The method of claim 1 wherein the method is initiated periodically.

3. The method of claim 1 wherein the method is initiated in response to one of the cells of the multi-mode base station hitting a threshold of low resource availability.

4. The method of claim 1 wherein the first radio access technology is suited to a first set of services, the second radio access technology is suited to a second set of services, monitoring the operating conditions of the first and second cells comprises monitoring the services used by the user equipment in the first cell, and determining that making a handover of the user equipment to the second cell would provide a performance improvement comprises determining that the services used by the user equipment in the first cell are in the second set of services.

5. The method of claim 4 wherein monitoring the services used by the user equipment in the first cell comprises at least one of:
(i) examining service requests exchanged between the user equipment and the first cell; and
(ii) determining Quality of Service parameters applied to the communication between the user equipment and the first cell of the multi-mode base station.

6. The method of claim 1 wherein the step of monitoring the operating conditions of the first and second cells comprises monitoring the throughput at which the user equipment is operating in the first cell, and the step of determining that making a handover of the user equipment to the second cell would provide a performance improvement comprises determining that the monitored throughput uses all of the bandwidth available to the user equipment in the first cell using the first radio access technology, and that the user equipment could achieve a greater throughput if it operated in the second cell using the second radio access technology.

7. The method of claim 1 wherein the user equipment is one of a plurality of user equipment operating in the first cell and the monitored operating conditions comprises an indication that the first cell has hit a threshold of low resource availability.

8. The method of claim 1 wherein determining that making a handover of the user equipment to the second cell would provide a performance improvement comprises determining which of the plurality of user equipment has Quality of Service requirements which would be satisfied if the user equipment were operated using the second radio access technology in the second cell, and as a result, the method further comprises making a handover of the determined user equipment to the second cell.

9. The method of claim 1 wherein the user equipment is one of a plurality of user equipment communicating with the multi-mode base station and the method further comprises:
determining an effect of operating the multi-mode base station for each of a plurality of different arrangements in which the user equipment is allocated to operate in different ones of the cells to thereby determine an optimum arrangement for allocating the user equipment to operate in the cells; and
making a handover of at least one of the user equipment between the cells to thereby implement the optimum arrangement.

10. The method of claim 1 wherein the performance improvement is one of:
(i) an improvement in the throughput or Quality of Service achieved by the user equipment;
(ii) an improvement in a combined throughput or Quality of Service achieved by a plurality of user equipment communicating with the multi-mode base station; and
(iii) an improvement in a combined throughput or Quality of Service achieved by the user equipment or a plurality of user equipment communicating with at least one of (a) the multi-mode base station, and (b) at least one other neighbouring base station.

11. The method of claim 1 wherein the step of monitoring operating conditions comprises at least one of:
(i) receiving, from the user equipment, measurement events of the cells of the multi-mode base station and of neighbouring cells;
(ii) receiving, from the user equipment, periodic measurements of the cells of the multi-mode base station and of neighbouring cells;
(iii) performing, by the multi-mode base station, periodic measurements of neighbouring cells;
(iv) determining periodic indications of victim cell loading received from neighbour cells;
(v) detecting nearby victim user equipment;
(vi) measuring noise plus interference at the multi-mode base station;
(vii) detecting loading changes on the cells of the multi-mode base station; and
(viii) determining a change in service class for the user equipment when the user equipment sends a service request to the multi-mode base station.

12. A multi-mode base station arranged to operate as a plurality of cells, the plurality of cells comprising a first cell using a first radio access technology and a second cell using a second radio access technology, and the base station comprising a radio resource manager for controlling communication between a user equipment and the multi-mode base station, the radio resource manager being configured to perform operations of:
monitoring operating conditions of the first cell and the second cells, the user equipment operating in the first cell;
based on the monitored operating conditions of the first and second cells, determining that making a handover of the user equipment to the second cell would provide a performance improvement; and
in response to determining that making a handover of the user equipment to the second cell would provide a performance improvement, making a handover of the user equipment to the second cell to provide the performance improvement.

13. The multi-mode base station of claim 11 wherein the multi-mode base station is a dual-mode femtocell.

14. A computer program product embodied on a non-transient computer-readable medium and configured such that when executed on a processor of the multi-mode base station to perform the operations for controlling communication between a user equipment and a multi-mode base station, the multi-mode base station being arranged to operate as a plurality of cells, the plurality of cells comprising a first cell using a first radio access technology and a second cell using a second radio access technology, and the computer program product configured to execute on a processor of the multi-mode base station to perform the operations of:
monitoring operating conditions of the first cell and the second cells, the user equipment operating in the first cell;
based on the monitored operating conditions of the first and second cells, determining that making a handover of the user equipment to the second cell would provide a performance improvement; and
in response to determining that making a handover of the user equipment to the second cell would provide a performance improvement, making a handover of the user equipment to the second cell, to provide the performance improvement.
